(19) United States
(12) Patent Application Publication
(10) Pub. No.: US 2007/0214347 A1
(43) Pub. Date: Sep. 13, 2007

(54) Method and apparatus for performing staged memory initialization

(76) Inventors: Michael A. Rothman, Puyallup, WA (US); Vincent J. Zimmer, Federal Way, WA (US)

Correspondence Address: Lawrence Cho Attorney at Law;c/oPortfolioIP, P.O. Box 52050, Minneapolis, MN, 55402, US

(21) Appl. No.: 11/374,586

(22) Filed: Mar. 13, 2006

(51) Int. Cl. G06F 15/177

(52) U.S. Cl. 713/1

(57) ABSTRACT

A method for managing a memory includes initializing a section of the memory. An operating system is executed in the section of the memory before remaining sections of the memory are initialized. According to an embodiment of the present invention, additional sections in the memory are initialized after the operating system has been executed. According to another embodiment of the present invention, a notification is generated to inform the operating system that the additional sections in memory are available.

### TECHNICAL FIELD

Embodiments of the present invention pertain to managing a memory system. More specifically, embodiments of the present invention relate to a method and apparatus for performing staged memory initialization.

### BACKGROUND

When a basic input output system (BIOS) boots a computer system, it performs a Power-On Self-Test (POST). The POST is a built-in diagnostic program that checks the hardware in the computer system to ensure that the necessary components for operating the computer system are present and functioning properly before beginning the actual boot. The BIOS continues with additional tests including a memory test. Some memory tests involve setting an initial state of memory and parity syndrome bits to zero upon a system restart. This operation may consume tens of seconds on computer systems having gigabytes of memory and may consume over a minute for some larger systems. The setting of memory may not be done in parallel because concurrent memory access has been found to engender a current flow that is difficult for a power supply to support. Thus, for computer systems having a large amount of memory, the memory test may consume a significant amount of time which noticeably delays the time when an operating system may be launched.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 is a block diagram of a first embodiment of a computer system in which an example embodiment of the present invention resides.

FIG. 2 is a block diagram of a basic input output system used by a computer system according to an example embodiment of the present invention.

FIG. 3 is a block diagram of a memory initialization module according to an example embodiment of the present invention.

FIG. 4 is a diagram illustrating the timing associated with staged initialization.

FIGS. 5 is a flow chart illustrating a method for managing a memory according to an example embodiment of the present invention.

FIG. 6 is a flow chart illustrating a method for initializing memory after a first section is initialized according to an embodiment of the present invention.

### DETAILED DESCRIPTION

In the following description, for purposes of explanation, specific nomenclature is set forth to provide a thorough understanding of embodiments of the present invention. However, it will be apparent to one skilled in the art that these specific details may not be required to practice the embodiments of the present invention. In other instances, well-known circuits, devices, and programs are shown in block diagram form to avoid obscuring embodiments of the present invention unnecessarily.

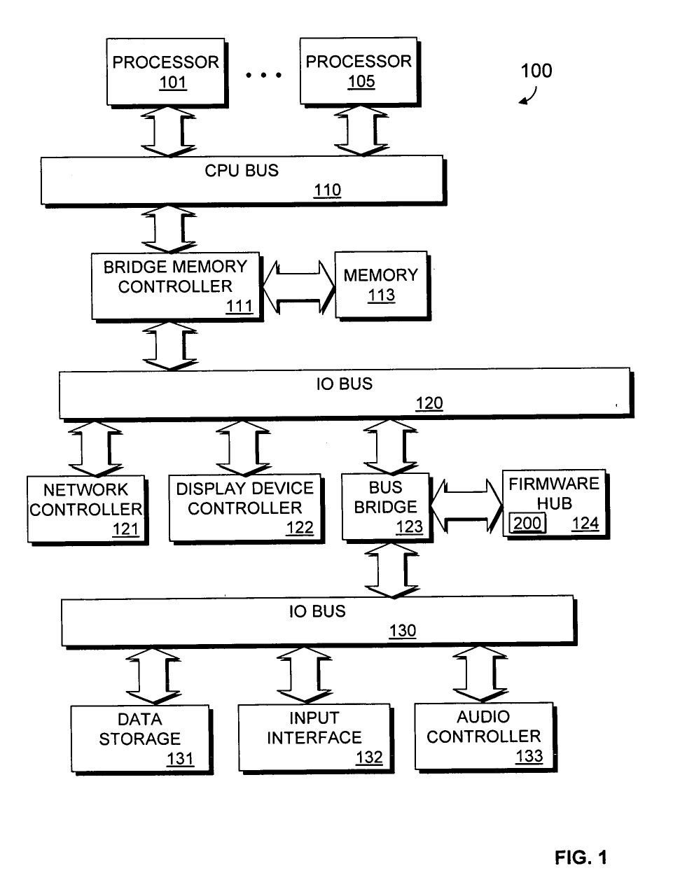

FIG. 1 is a block diagram of a first embodiment of a computer system 100 in which an example embodiment of the present invention resides. The computer system 100 includes one or more processors that process data signals. As shown, the computer system 100 includes a first processor 101 and an nth processor 105, where n may be any number. The processors 101 and 105 may be complex instruction set computer microprocessors, reduced instruction set computing microprocessors, very long instruction word microprocessors, processors implementing a combination of instruction sets, or other processor devices. The processors 101 and 105 may be multi-core processors with multiple processor cores on each chip. The processors 101 and 105 are coupled to a CPU bus 110 that transmits data signals between processors 101 and 105 and other components in the computer system 100.

The computer system 100 includes a memory 113. The memory 113 includes a main memory that may be a dynamic random access memory (DRAM) device. The memory 113 may store instructions and code represented by data signals that may be executed by the processors 101 and 105. A cache memory (processor cache) may reside inside each of the processors 101 and 105 to store data signals from memory 113. The cache may speed up memory accesses by the processors 101 and 105 by taking advantage of its locality of access. In an alternate embodiment of the computer system 100, the cache may reside external to the processors 101 and 105.

A bridge memory controller 111 is coupled to the CPU bus 110 and the memory 113. The bridge memory controller 111 directs data signals between the processors 101 and 105, the memory 113, and other components in the computer system 100 and bridges the data signals between the CPU bus 110, the memory 113, and a first input output (IO) bus 120.

The first IO bus 120 may be a single bus or a combination of multiple buses. The first IO bus 120 provides communication links between components in the computer system 100. A network controller 121 is coupled to the first IO bus 120. The network controller 121 may link the computer system 100 to a network of computers (not shown) and supports communication among the machines. A display device controller 122 is coupled to the first IO bus 120. The display device controller 122 allows coupling of a display device (not shown) to the computer system 100 and acts as an interface between the display device and the computer system 100.

A second IO bus 130 may be a single bus or a combination of multiple buses. The second IO bus 130 provides communication links between components in the computer system 100. A data storage device 131 is coupled to the second IO bus 130. The data storage device 131 may be a hard disk drive, a floppy disk drive, a CD-ROM device, a flash memory device or other mass storage device. An input interface 132 is coupled to the second IO bus 130. The input interface 132 may be, for example, a keyboard and/or mouse controller or other input interface. The input interface 132 may be a dedicated device or can reside in another device such as a bus controller or other controller. The input interface 132 allows coupling of an input device to the computer system 100 and transmits data signals from an input device to the computer system 100. An audio controller 133 is coupled to the second IO bus 130. The audio controller 133 operates to coordinate the recording and playing of sounds.

A bus bridge 123 couples the first IO bus 120 to the second IO bus 130. The bus bridge 123 operates to buffer and bridge data signals between the first IO bus 120 and the second IO bus 130. A firmware hub 124 is coupled to the bus bridge 123. The firmware hub 124 may be coupled to the bus bridge 123 via a low-pin-count (LPC) bus or other connection. According to one embodiment, the firmware hub 124 includes a non-volatile memory such as read only memory. The non-volatile memory stores instructions and code represented by data signals that may be executed by the processor 101 and/or processor 105. The computer system basic input output system (BIOS) may be stored on the non-volatile memory. The BIOS may operate to initialize the memory 113 in more than one stages. According to one embodiment, the BIOS may initialize a first section in memory during a first stage, where the first section is sufficient to load and execute an operating system for the computer system 100. The BIOS may initialize the remaining sections of memory after the operating system has been launched (loaded and executed). Alternately, an extensible framework interface and a platform innovation framework may be used in place of the BIOS where the computer system 100 implements the Extensive Firmware Interface Specification (EFI 1.10 Specification, published 2004).

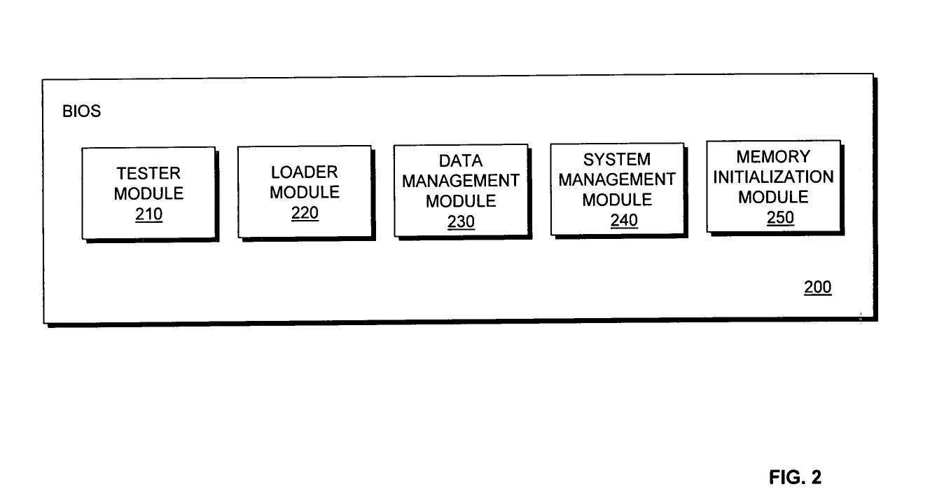

FIG. 2 is a block diagram of a BIOS 200 used by a computer system according to an example embodiment of the present invention. The BIOS 200 may be used to implement the BIOS stored in a firmware hub such as the one shown as 124 in FIG. 1. The BIOS 200 includes programs that may be run when a computer system is booted up and programs that may be run in response to triggering events. The BIOS 200 may include a tester module 210. The tester module 210 performs a POST to determine whether the components on the computer system are operational.

The BIOS 200 may include a loader module 220. The loader module 220 locates and loads programs and files to be executed by a processor on the computer system. The programs and files may include, for example, boot programs, system files (e.g. initial system file, system configuration file, etc.), and the operating system.

The BIOS 200 may include a data management module 230. The data management module 230 manages data flow between the operating system and components on the computer system. The data management module 230 may operate as an intermediary between the operating system and components on the computer system and operate to direct data to be transmitted directly between components on the computer system.

The BIOS 200 may include a system management mode module 240. According to an embodiment of the present invention, a memory controller, such as the bridge memory controller 111 (shown in FIG. 1), identifies various events and timeouts. When such an event or timeout occurs, a system management interrupt (SMI) is asserted which puts a processor into system management mode (SMM). In SMM, the system management module 240 saves the state of the processor(s) and redirects all memory cycles to a protected area of main memory reserved for SMM. The system management module 240 includes an SMI handler. The SMI handler determines the cause of the SMI and operates to resolve the problem. According to an embodiment of the present invention, platform management interrupts (PMI), or other types of interrupts may be asserted.

The BIOS 200 includes a memory initialization module 250. The memory initialization module 250 performs staged memory initialization. According to an embodiment of the BIOS 200, the memory initialization module initializes a first section in memory without initializing the entire memory. The first section of memory is sufficient for loading and executing an operating system. After the operating system is loaded in the first section of memory and executing, the memory initialization module 250 may proceed to initialize additional sections in the memory. The memory initialization module 250 provides notification to the operating system when additional sections in memory are available for use.

It should be appreciated that the BIOS 200 may include additional modules to perform other tasks. The tester module 210, loader module 220, data management module 230, system management module 240, and memory initialization module 250 may be implemented using any appropriate procedure or technique. According to an embodiment of the present invention, the memory initialization module 250 may also be implemented by one or more of the other components in the BIOS 200, such as the tester module 210 and the system management module 240. It should be appreciated that if a computer system is compliant with the EFI Specification, the BIOS 200 and its components may be implemented using a plurality of modular interfaces based on drivers.

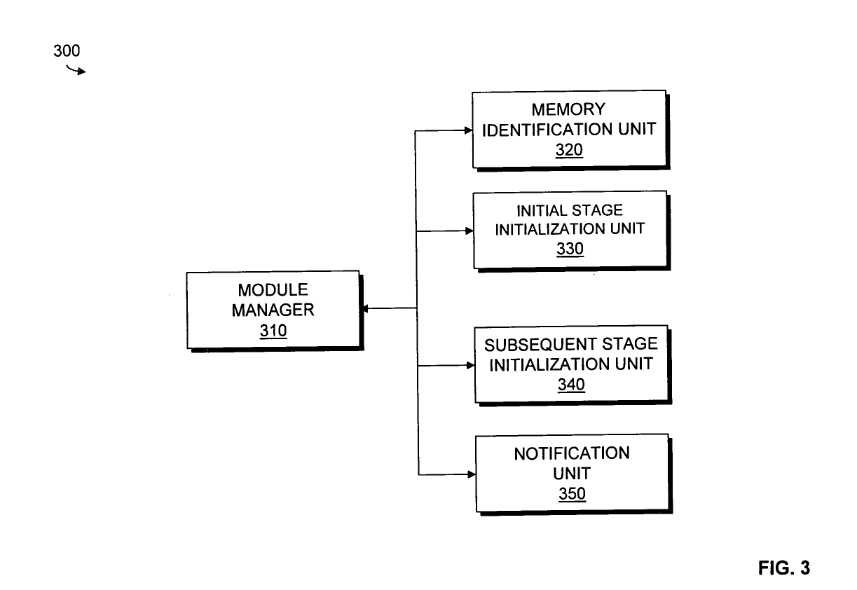

FIG. 3 is a block diagram of a memory initialization module 300 according to an example embodiment of the present invention. The memory initialization module 300 may be implemented as the memory initialization module 200 shown in FIG. 2. The memory initialization module 300 includes a module manager 310. The module manager 310 interfaces with and transmits information between other components in the memory initialization module 300.

The memory initialization module 300 includes a memory identification unit 320. The memory identification unit 320 identifies properties of a memory in a computer system. The properties may be used by the memory initialization unit 300 to perform a staged memory initialization. According to an embodiment of the memory initialization module 300, the memory identification unit 320 may identify a number of slots in a computer system that may be used for inserting memory components and whether the slots are populated. The memory initialization module 300 may also identify a type of memory and the size of the memory in a computer system. This may be achieved, for example, by reading a vender and/or product identification of the memory.

The memory initialization module 300 includes an initial stage initialization unit 320. The initial stage initialization unit 320 determines a size of a section in memory to initialize to support the operation of an operating system for a computer system. According to an embodiment of the memory initialization module 300, the initial stage initialization unit 320 makes this determination from retrieving information about the computer system and/or the operating system. The initial stage initialization unit 320 may also retrieve information provided to it by a BIOS programmer. The initial stage initialization unit 320 initializes the section in memory. Initialization of the memory may include performing tests on the memory, writing initialization values into the memory, scrubbing the memory, and/or other procedures. According to an embodiment of the memory initialization module 300, the initial stage initialization unit 320 prompts a BIOS to load the operating system into the section of memory and execute (launch) the operating system prior to the initialization of additional sections of the memory.

The memory initialization module 300 includes a subsequent stage initialization unit 340. The subsequent stage initialization unit 340 initializes additional sections of the memory (memory locations) after the launching of the operating system. According to an embodiment of the memory initialization module 300, the subsequent stage initialization unit 340 coordinates the initialization of additional sections of memory with a system management mode module. In this embodiment, additional memory is initialized in system management mode when an SMI is generated. The SMI may be generated in response to a timer or watchdog set by a bridge memory controller, bus bridge or other component. An SMI handler would recognize that additional memory is available for initialization and begin initializing additional sections. The remainder of the memory would be initialized a section at a time as permitted by the period defined for system management modes. In this embodiment, each section may or may not include the same number of memory locations.

According to an embodiment of the present invention where one or more dedicated processors or processor cores are utilized to perform system management procedures, the subsequent stage initialization unit 340 may be implemented by the one or more dedicated processors or processor cores as an independent memory initialization agent. In this embodiment, the subsequent state initialization unit 340 may operate to initialize additional sections in memory concurrently with the execution of the operating system and other programs. In contrast to the embodiment where additional memory is initialized during system management mode, the remainder of the memory may be initialized without incurring platform stage change overhead and be performed at a faster rate.

The memory initialization module 300 includes a notification unit 350. The notification unit 350 generates a notification to the operating system when additional memory that has been initialized is available. According to an embodiment of the memory initialization module 300, the notification unit 350 may generate a notification after any amount of memory has become available. This may be utilized when the memory is initialized a section at a time during system management mode. Alternatively, the notification unit 350 may generate a notification after a predetermined amount of memory has become available or when the remainder of the memory has become available. The notification may identify memory locations that have been initialized and are available. According to an embodiment of the memory initialization module 300, the notification to the operating system may be in the form of a “memory hot plug” or “hot-insertion” event as defined by the Advanced Configuration and Power Interface (ACPI) Specification (ACPI 3.0 published September 2004).

Although the memory initialization module 300 has been described with reference to operating within a BIOS, it should be appreciated that the memory initialization module 300 may also be implemented in an application run on one or more out of band processors or cores, such as a service processor. Alternatively, the memory initialization module 300 may be implemented in an application for an operating system or be implemented in other environments.

It should be appreciated that the module manager 310, memory identification unit 320, initial stage initialization unit 330, subsequent stage initialization unit 340, and notification unit 350 may be implemented using any appropriate procedure or technique.

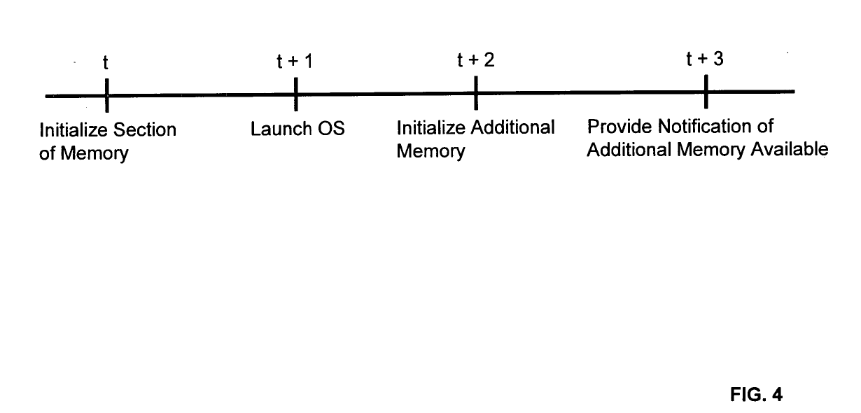

FIG. 4 is a diagram illustrating the timing associated with staged initialization. At time t, a computer system is powered on and the boot process is initiated. During time t, a section of memory is initialized. The section of memory represents a sub-section of the entire memory.

At time t+1, an operating system for the computer system is loaded into the section of memory that is initialized. The operating system is run (launched) and allowed to manage the computer system.

At t+2, additional memory is initialized. The additional memory may be initialized during system management mode with the assistance of an SMI handler or alternatively the additional memory may be initialized by a dedicated memory initialization agent implemented by one or more dedicated processors or processor cores.

At t+3, notification is provided to the operating system that additional memory has been initialized and is available.

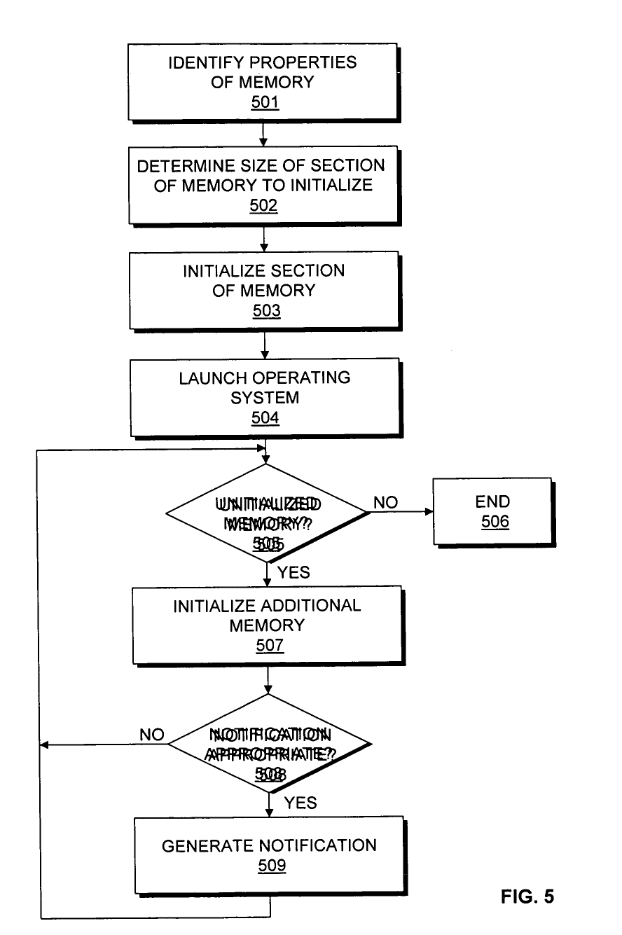

FIG. 5 is a flow chart illustrating a method for managing a memory according to an example embodiment of the present invention. At 501, properties of a memory used by a computer system is identified. According to an embodiment of the present invention, the properties may include a type of the memory and the size of the memory. This may be achieved, for example, by reading a vender and/or product identification of the memory.

At 502, a size of a section of memory for an initialization is determined. The size of the section should support the operation of an operating system for a computer system. According to an embodiment of the present invention, the determination may be made from retrieving information about the computer system, the operating system, and/or information provided to it by a BIOS programmer.

At 503, the section in memory is initialized. According to an embodiment of the present invention, initialization of the memory may include performing tests on the memory, writing initialization values into the memory, scrubbing the memory, and/or other procedures.

At 504, the operating system is launched. The operating system is loaded into the section of initialized memory and run. According to an embodiment of the present invention, a BIOS is prompted to load the operating system into the section of memory and execute (launch) the operating system prior to the initialization of additional sections of the memory.

At 505, it is determined whether uninitialized memory exists. If unitialized memory does not exist, control proceeds to 506. If uninitialized memory exists control proceeds to 507.

At 506, since all memory has been initialized, control terminates the procedure.

At 507, additional memory is initialized. According to an embodiment of the present invention, additional memory may be initialized during system management mode by a SMI handler. According to an alternate embodiment of the present invention, a dedicated memory initialization agent performs the initialization of the additional memory.

At 508, it is determined whether generation of a notification to indicate that additional memory is available would be appropriate. According to an embodiment of the present invention, a notification may be generated when any amount of additional memory has been initialized and is available, when a predetermined amount of memory has been initialized and is available, or when the remainder of the memory has been initialized and is available. If generation of a notification is not appropriate, control returns to 505. If generation of a notification is appropriate, control proceeds to 509.

A 509, a notification is generated to the operating system. The notification may identify the memory locations that have been initialized and are available. According to one embodiment, the notification to the operating system may be in the form of a “memory hot plug” or “hot-insertion” event as defined by the Advanced Configuration and Power Interface Specification. Control returns to 505.

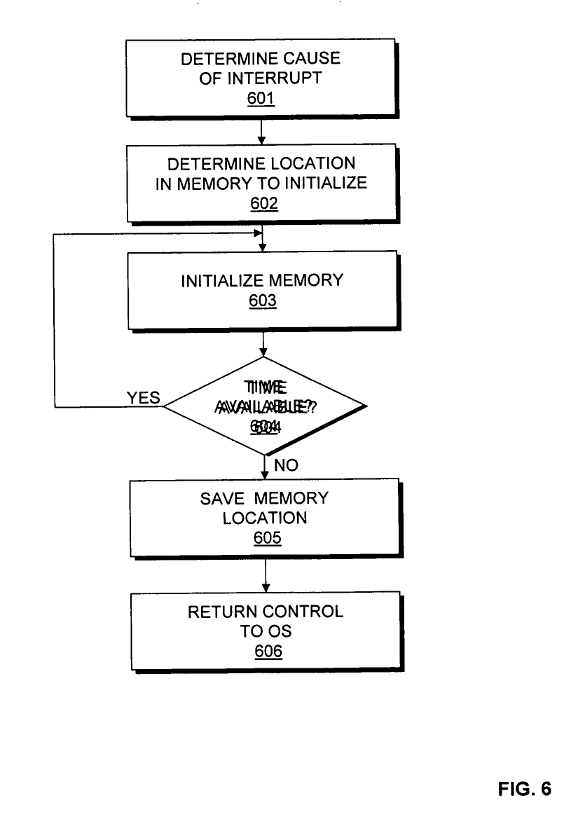

FIG. 6 is a flow chart illustrating a method for performing subsequent stage memory initialization according to an embodiment of the present invention. The procedure illustrated in FIG. 6 may be utilized by an SMI handler to implement 505 and 507, in part, according to an embodiment of the present invention. At 601, a cause of the interrupt is determined. According to an embodiment of the present invention, a list of possible errors and timeouts are checked. In this embodiment, a confirmation that the cause of the interrupt is to initialize additional memory is obtained before proceeding to 602.

At 602, a memory location to begin initialization is determined. According to an embodiment of the present invention, the address of the last memory location that was initialized is retrieved.

At 603, additional memory locations are initialized. Initialization may include performing tests on the memory, writing initialization values into the memory, scrubbing the memory, and/or other procedures.

At 604, it is determined whether additional time is available to continue initialization. According to an embodiment of the present invention, the time period allowed for system management mode is checked. If the time period has expired, initialization must stop. If additional time is available, control returns to 603. If additional time is not available, control proceeds to 605.

At 605, the address of the last memory location to be initialized is recorded. This address may be utilized the next time the computer system enters system management mode for memory initialization.

At 606, control is returned to the operating system.

FIGS. 5 and 6 are flow charts illustrating methods according to embodiments of the present invention. Some of the techniques illustrated in these figures may be performed sequentially, in parallel, or in an order other than that which is described. It should be appreciated that not all of the techniques described are required to be performed, that additional techniques may be added, and that some of the illustrated techniques may be substituted with other techniques.

Embodiments of the present invention may be provided as a computer program product, or software, that may include an article of manufacture on a machine accessible or machine readable medium having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

In the foregoing specification, the embodiments of the present invention have been described with reference to specific exemplary embodiments thereof. It will, however, be evident that various modifications and changes may be made thereto without departing from the broader spirit and scope of the embodiments of the present invention. The specification and drawings are, accordingly, to be regarded in an illustrative rather than restrictive sense.

What is claimed is:

1. A method for managing a memory, comprising:
initializing a section of the memory; and
executing an operating system in the section of the memory before remaining sections of the memory are initialized.

2. The method of claim 1, further comprising identifying the memory.

3. The method of claim 1, further comprising identifying the memory by determining a size of the memory.

4. The method of claim 1, further comprising identifying the memory by determining a type of the memory.

5. The method of claim 1, further comprising determining a size of the memory to initialize.

6. The method of claim 1, further comprising determining a size of the memory to initialize from properties of the operating system.

7. The method of claim 1, further comprising initializing additional sections in memory.

8. The method of claim 1, further comprising initializing additional sections in memory during a system management mode.

9. The method of claim 1, further comprising initializing additional sections in memory after the operating system has been launched.

10. The method of claim 1, wherein initializing the section in memory comprises performing a memory scrub on the section in the memory.

11. The method of claim 1, further comprising:
initializing additional sections in memory; and
generating a notification to the operating system that the additional sections in memory are available.

12. The method of claim 1, further comprising:
initializing additional sections in memory; and
generating a memory hot plug alert to the operating system.

13. An article of manufacture comprising a machine accessible medium including sequences of instructions, the sequences of instructions including instructions which when executed cause the machine to perform:
initializing a section of the memory; and
executing an operating system in the section of the memory before remaining sections of the memory are initialized.

14. The article of manufacture of claim 13, further comprising instructions which when executed cause the machine to perform determining a size of the memory to initialize.

15. The article of manufacture of claim 13, further comprising instructions which when executed cause the machine to perform initializing additional sections in memory.

16. The article of manufacture of claim 13, further comprising instructions which when executed cause the machine to perform:
initializing additional sections in memory; and
generating a notification to the operating system that the additional sections in memory are available.

17. A basic input output system, comprising:
a loader module to load an operating system; and
a memory initialization unit to initialize a section in memory and to prompt the loader module to load the operating system in the section before remaining sections of the memory are initialized.

18. The apparatus of claim 17, wherein the memory initialization unit comprises a memory identification unit to determine a size of the memory.

19. The apparatus of claim 17, wherein the memory initialization unit comprises a a subsequent stage initialization unit to initialize one or more additional sections of the memory.

20. The apparatus of claim 17, wherein the memory initialization unit comprises:
a subsequent stage initializer to initiate one or more additional sections of the memory; and
a notification unit to generate a notification to the operating system that one or more additional sections in memory are available.
